(19) United States
(12) Patent Application Publication
(10) Pub. No.: US 2003/0009667 A1
(43) Pub. Date: Jan. 9, 2003

(54) Data terminal device that can easily obtain content data again, a program executed in such terminal device, and recording medium recorded with such program

(75) Inventors: Keiji Horiuchi, Anpachi-gun (JP); Takatoshi Yoshikawa, Ogaki-shi (JP); Toshiaki Hioki, Ogaki-shi (JP); Yoshihiro Hori, Gifu-shi (JP)

Correspondence Address: ARMSTRONG,WESTERMAN & HATTORI, LLP, 1725 K STREET, NW., SUITE 1000, WASHINGTON, DC, 20006, US

(73) Assignee: Sanyo Electric Co., Ltd., Moriguchi-shi (JP)

(21) Appl. No.: 10/187,894

(22) Filed: Jul. 3, 2002

(30) Foreign Application Priority Data
Jul. 9, 2001 (JP) 2001-207428 (P)

(51) Int. Cl. H04L 9/00

(52) U.S. Cl. 713/168

(57) ABSTRACT

In a cellular phone, a controller stores content data and additional information obtained from a distribution server into a memory. When the content data is to be transmitted to a memory card, a random number key generation unit generates a license key. An encryption processing unit encrypts the content data using the license key. The controller transmits the encrypted content data to the memory card via a memory card interface. Then, the controller deletes only the content data stored in the memory. As a result, distribution of content data that must be deleted when the obtained content data is to be transmitted to another apparatus can be facilitated while protecting copyright thereof.

### BACKGROUND OF THE INVENTION

1. Field of the Invention

The present invention relates to a data terminal device and program facilitating distribution of content data that must be deleted when transmitting the obtained content data to another apparatus while protecting copyright thereof, and a recording medium recorded with such a program.

2. Description of the Background Art

By virtue of the progress in information communication networks and the like such as the Internet in the few years, each user can now easily access network information through individual-oriented terminals employing a cellular phone or the like.

By the recent incorporation of Java® into cellular phones, it is possible to receive software from a server and display various image data at the display of a cellular phone using the received software. It is also possible to receive game software through a cellular phone from a server and enjoy playing the game through the cellular phone based on the received software.

When the user transmits such software received at his/her cellular phone to another cellular phone or into his/her own recording medium, the software stored in the memory of his/her own cellular phone has to be deleted.

In the case where the user gives away a certain software program resident in his/her cellular phone to another user, the former user could not use again that presented software since it is deleted from his/her cellular phone.

### SUMMARY OF THE INVENTION

In view of the foregoing, an object of the present invention is to provide a data terminal device facilitating distribution of obtained content data that must be deleted when transmitting to another apparatus while protecting the copyright thereof.

Another object of the present invention is to provide a program executed in a data terminal device facilitating distribution of obtained content data that must be deleted when transmitting to another apparatus while protecting the copyright.

A further object of the present invention is to provide a recording medium recorded with a program executed in a data terminal device facilitating distribution of obtained content data that must be deleted when transmitting to another apparatus while protecting the copyright.

According to the present invention, a data terminal device obtains content data and acquirement information required to obtain content data again from an external source and stores the same to use the content data. The data terminal device includes an operation unit to input a designation, a storage unit to store content data and acquirement information, and a control unit. The control unit functions to control the storage unit so as to store acquirement information corresponding to content data that is to be deleted in the case where content data stored in the storage unit is to be deleted according to a designation from the operation unit, and to obtain the deleted content data again from an external source based on the acquirement information stored in the storage unit and store the content data in the storage unit when designated to use the deleted content data by the operation unit.

Preferably the storage unit further stores a list information including the storage status and identification code of a plurality of content data that are currently or previously stored. When content data and acquirement information are newly obtained according to a designation from the operation unit, the control unit stores the newly obtained content data and acquirement information in the storage unit, and adds the storage status and identification code of the newly obtained content data into the list information. When the content data stored in the storage unit is to be deleted according to a designation from the operation unit, the control unit modifies the storage status corresponding to the content data to be deleted so that confirmation can be made of the content data to be deleted not stored in the storage unit. When the deleted content data is obtained again from an external source, the control unit modifies the storage status corresponding to the content data obtained again so that confirmation can be made that the re-obtained content data is stored in the storage unit. When usage of content data is designated from the operation unit, the control unit confirms whether the designated content data is stored in the storage unit based on the list information.

Preferably, the list information further includes acquirement information. When content data is newly acquired from an external source, the control unit also obtains acquirement information corresponding to the obtained content data. The obtained acquirement information is stored in the list information.

Preferably, the data terminal device further includes an interface to transfer data with a data recording apparatus. When content data is transmitted to a data recording apparatus via the interface, the control unit deletes the former content data.

Preferably, the data terminal device further includes an interface that transfers data with a data recording apparatus. When content data is transmitted to a data recording apparatus via the interface, the control unit updates the list information, and deletes the former content data.

Preferably, the data terminal apparatus also includes an encrypted content generation unit generating a license key required to decrypt encrypted content data that is an encrypted version of content data, and encrypts the content data using the generated license key to generate encrypted content data. When content data is to be transmitted to a data recording apparatus, the encrypted content generation unit generates a license key and encrypts the content data using the generated license key. The control unit transmits the encrypted content data generated by the encrypted content generation unit to the data recording apparatus via the interface.

Preferably, the data terminal device also includes a license generation unit generating a license including a license key. The license is required to substantially delete from the data recording apparatus the license key stored in the data recording apparatus when the license key is output from the data recording apparatus.

Preferably, the license generation unit generates a license from a usage rule having the number of times of decrypting and reproducing encrypted content data to one, and a license key.

Preferably, the encrypted content generation unit includes a key generation unit generating a license key, and an encryption processing unit encrypting content data using the license key.

Preferably, when content data is to be obtained, the control unit obtains only the content data, not acquirement information, when acquirement information corresponding to the content data is present in said storage unit.

Preferably, content data is data or a program executable in plaintext.

Preferably, when acquirement information corresponding to content data is obtained together with the content data, the control unit preferably stores the obtained acquirement information in the storage unit.

Preferably, when content data is newly obtained from an external source, the control unit preferably generates acquirement information corresponding to the obtained content data, and stores the generated acquirement information in the storage unit.

According to the data terminal device of the present invention, even if content data obtained from an external source is deleted, acquirement information required to obtain the deleted content data again is stored in the data terminal device. Therefore, deleted content data can be used again according to the present invention.

A program according to the present invention causes a computer to execute a first step of obtaining content data in plaintext, a second step of storing additional information including at least access information to access the acquirement source of content data and the obtained content data into a storage unit, a third step of generating a license key required to decrypt encrypted content data that is an encrypted version of content data, and using the generated license key to encrypt the content data to generate encrypted content data, a fourth step of generating a license including a license key, and required to substantially delete the license key recorded in the data recording apparatus from the data recording apparatus when the license key is output from the data recording apparatus, a fifth step of generating an encrypted license which is an encrypted version of the license, a sixth step of transmitting the encrypted content data, encrypted license, and additional information to a data recording apparatus, and a seventh step of deleting content data stored in the storage unit.

Preferably in the first step, additional data is generated when content data is obtained.

Preferably, additional information is obtained together with the content data in the first step.

According to the present invention, content data can be distributed while preventing copying of content data, and content data stored in a data recording apparatus can be easily obtained again.

A recording medium according to the present invention is a computer-readable recording medium recorded with the above-described program.

According to the present invention, a program aimed to distribute content data while protecting copyright thereof can be widely distributed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram to describe a communication system.

FIG. 2 shows the characteristics of data, information and the like for communication in the communication system of FIG. 1.

FIG. 3 shows the contents of additional information of FIG. 2.

FIG. 4 shows the characteristics of data, information and the like for authentication in the data distribution system of FIG. 1.

FIG. 5 is a schematic block diagram of a structure of a cellular phone in the communication system of FIG. 1.

FIG. 6 is a schematic block diagram of a structure of a memory card in the communication system of FIG. 1.

FIG. 7 is a flow chart to describe the operation of purchasing content data in the communication system of FIG. 1.

FIGS. 8 and 9 are the first and second flow charts, respectively, to describe storage of content data from a cellular phone to a memory card in the communication system of FIG. 1.

FIGS. 10 and 11 are first and second flow charts, respectively, to describe storage of content data from a memory card to a cellular phone in the communication system of FIG. 1.

FIG. 12 shows a license region and a data region in a memory of the memory card of FIG. 5.

FIGS. 13A and 13B show a structure of the memory of FIG. 5.

FIG. 14 is a flow chart to describe the operation of reproducing content data in the cellular phone of FIG. 1.

FIGS. 15A and 15B show other structures of the memory of FIG. 5.

### DESCRIPTION OF THE PREFERRED EMBODIMENTS

Embodiments of the present invention will be described in detail hereinafter with reference to the drawings. In the drawings, the same or likewise components have the same reference character allotted, and description thereof will not be repeated.

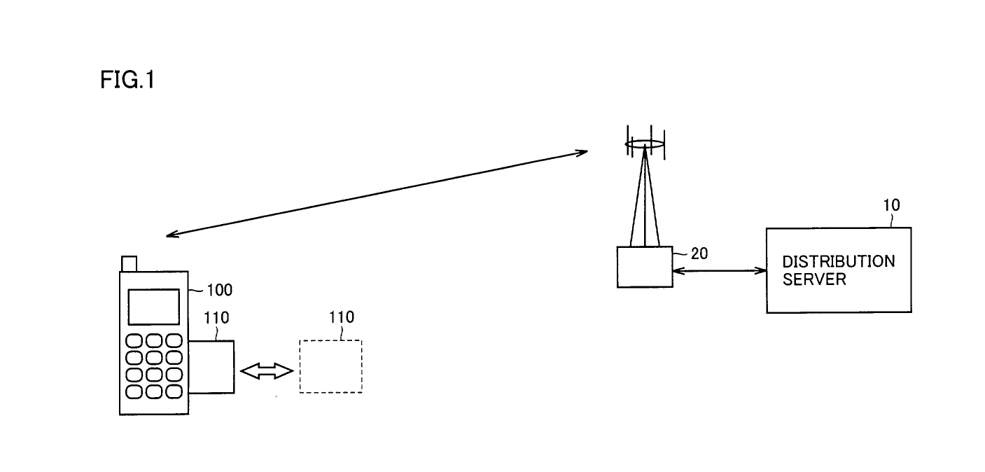

FIG. 1 is a schematic diagram of an entire structure of a communication system in which a data terminal device (cellular phone) obtains content data.

Content data implies all data executed or referred to in a state transferred to a memory in a terminal device such as image data (including motion picture data), audio data, game programs and the like. A program is taken by way of example as content data hereinafter.

Referring to FIG. 1, a distribution server 10 receives via a carrier 20 a program distribution request transmitted from a user with his/her cellular phone 100. Distribution server 10 responds to the received program distribution request to transmit a program to cellular phone 100 via carrier 20. In this case, distribution server 10 transmits the program in plaintext to cellular phone 200. Carrier 20 transmits the program distribution request from cellular phone 100 to distribution server 10, and transmits the program from distribution server 10 to cellular phone 100 through a cellular phone network.

Cellular phone 100 receives the program through the cellular phone network, and stores the received program in a built-in memory (not shown). The user of cellular phone 100 executes the received program to display various image data on the display of cellular phone 100 or plays various games through the display. In the case where the user wishes to store the program stored in the memory of cellular phone 100 to his/her memory card 110, the user attaches memory card 110 to cellular phone 100 and designates cellular phone 100 to store the program into memory card 110.

When a program is to be stored into memory card 110, cellular phone 100 generates a license key as will be described afterwards. The program stored in the memory is encrypted using the generated license key. The encrypted program is stored in memory card 110 together with a license such as the license key and additional information of the program. Upon storing the program into memory card 110, cellular phone 100 deletes the program stored in the memory. At this stage, cellular phone 100 stores a license having the reproduction limitation, i.e., limiting the output of the license key, added to the license. Specifically, cellular phone 100 stores the program stored in the memory into memory card 110 with the reproducible number of times limited to once. Details thereof will be described afterwards.

Thus, cellular phone 100 stores a program received from distribution server 10 in the built-in memory, and executes the stored program. When the program is to be stored into memory card 110 according to a designation from the user, cellular phone 100 deletes the program from the built-in memory. When the program is reproduced from memory card 110, i.e., when the encrypted program and the license including the license key have been output from memory card 110, the license key cannot be output from memory card 110 thereafter. Since cellular phone 100 stores the program into memory card 110 with the reproducible number of times set to once, the number of times of reproduction at memory card 110 will be set to “0” when the program is reproduced from memory card 110, i.e. when the license key has been output from memory card 110. Therefore, the license key cannot be output from memory card 110 thereafter. This means that, when the program is output to cellular phone 100 from memory card 110, the license key cannot be output from memory card 110 although the encrypted program is stored therein. Thus, the program will not be stored in both cellular phone 100 and memory card 110 in a usable state. The program can be stored only in a state that is usable by either cellular phone 100 or memory card 110.

Memory card 110 is detachable with respect to cellular phone 100. The user of cellular phone 100 can store the program residing in the memory of cellular phone 100 to memory card 110 and present that program to another user via that memory card 110. In other words, the program can be distributed while inhibiting arbitrary copying of the program. Storing the program into memory card 110 also provides the advantage that, even in the case where the user's cellular phone is changed to another one, the same program can be executed through that another cellular phone by attaching memory card 110 to that another cellular phone and read out the program from memory card 110.

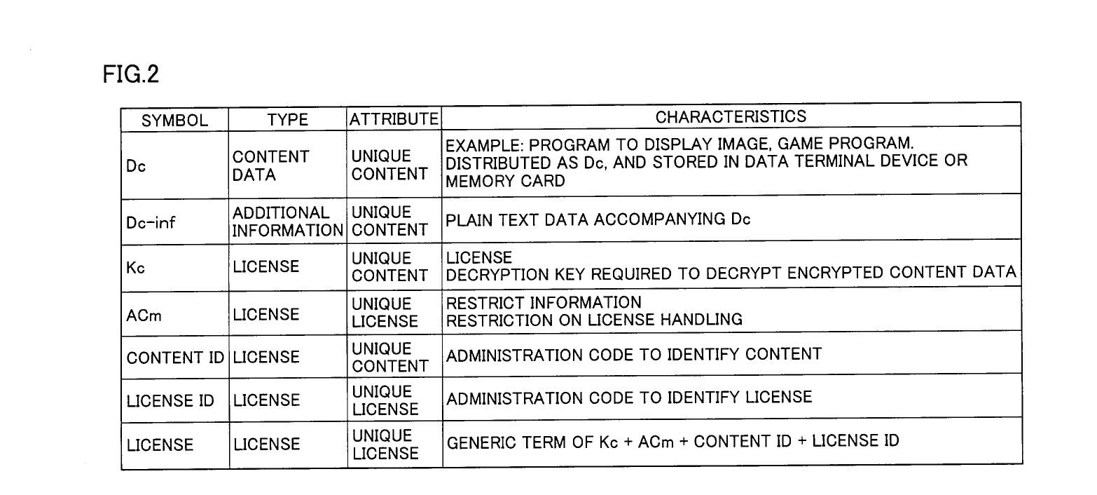

FIG. 2 is a diagram to describe the characteristics of data, information and the like for communication, used between distribution server 10 and cellular phone 100, or between cellular phone 100 and memory card 110.

First, the data distributed by distribution server 10 will be described. Dc designates content data formed of a program. Content data Dc is transmitted in plaintext from distribution server 10 to cellular phone 100 via carrier 20. The transmitted content data is stored in a data terminal device (cellular phone) or a memory card.

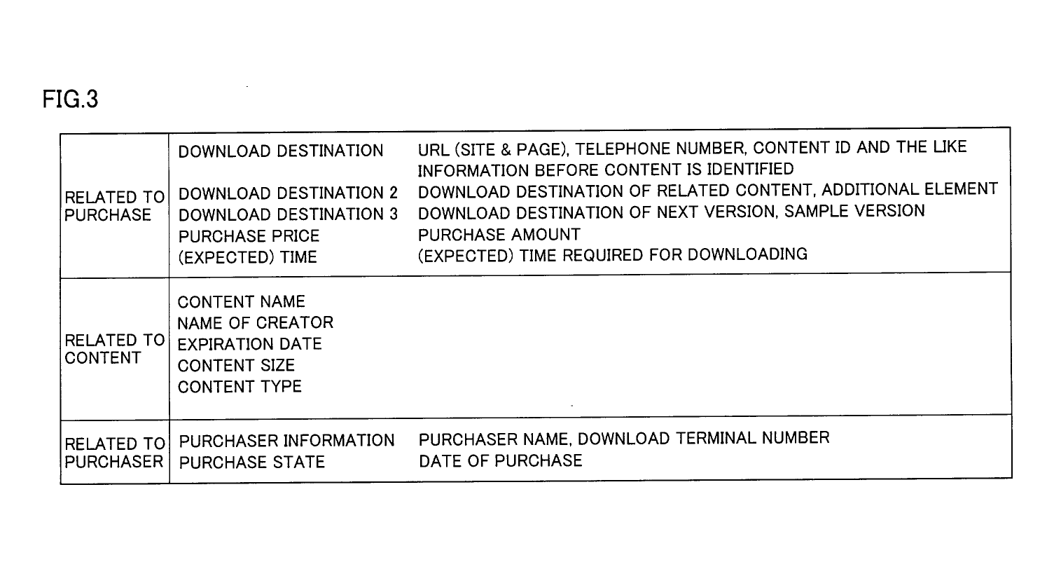

There is also additional information Dc-inf as plaintext data accompanying the content data. Referring to FIG. 3, additional information Dc-inf includes information related to purchase, information related to the contents, and information related to the purchaser. The information related to purchase includes a download destination, a download destination 2, a download destination 3, purchase price, and time. The download destination includes an access destination in downloading content data, i.e. the URL for connection with distribution server 10, a telephone number, a content ID and the like which are information prior to identification of the contents. Download destination 2 designates information indicating where the related contents and additional element are downloaded. Download destination 3 designates information indicating where the next version of the content data, and sample version or the like are downloaded. The purchase price is the amount to be paid to receive content data from distribution server 10. The time indicates the time required to download the content data.

The information related to contents includes the content name, the creator of content data, the expiration date of allowing re-downloading of content data, the content data size, and the content data type.

The information related to the purchaser includes purchaser information and the date of purchase. The purchaser information indicates the name of the purchaser, and the terminal number to which data is to be downloaded. This download terminal number is the number to identify cellular phone 100. The date of purchase indicates when content data is downloaded.

According to the present invention, cellular phone 100 stores additional information Dc-inf including the information shown in FIG. 3 into the memory together with the content data in the case where content data is received and stored into the memory from distribution server 10. There are some cases where additional information Dc-inf is distributed to cellular phone 100 together with content data from distribution server 10. There are also some cases where additional information Dc-inf is created at cellular phone 100 when content data is distributed to cellular phone 100.

Referring to FIG. 2 again, the license includes a license key Kc required to decrypt encrypted content data. License key Kc is generated at cellular phone 100 when the program stored in cellular phone 100 is transmitted to memory card 110. License key Kc is transferred between cellular phone 100 and memory card 110 together with encrypted content data {Dc} Kc that is encrypted using license key Kc. In the following, the representation of {Y} X implies that data Y has been encrypted in a form decryptable by a decryption key X.

The license also includes access restrict information ACm that is the information to restrict access of the license in a recording apparatus (memory card). Specifically, access restrict information ACm is the control information when license key Kc is to be output to an external source from a memory card, and includes the reproducible number of times (the number of times the license key can be output for reproduction).

The license also includes a content ID functioning as an administration code to identify the content data stored in the memory of cellular phone 100 when encrypted content data {Dc} Kc is to be transmitted from cellular phone 100 to memory card 110.

The license also includes a license ID functioning as an administration code to identify a license generated when encrypted content data {Dc} Kc is to be transmitted from cellular phone 100 to memory card 110.

License key Kc, access restrict information ACm, content ID and license ID are collectively referred to as “license” hereinafter.

It is assumed that access restrict information ACm restricts only the number of times of reproduction (0: reproduction disabled; 1: reproduction allowed count), which is the control information that restricts the number of times of reproduction.

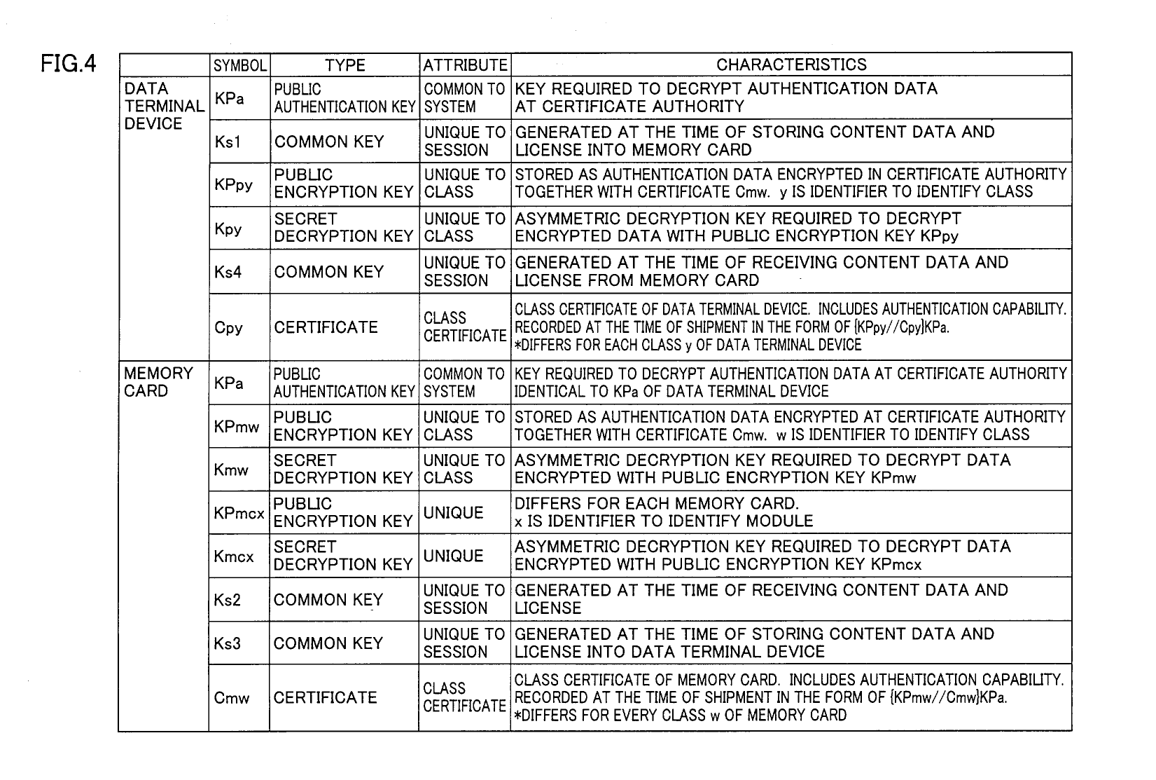

FIG. 4 is a diagram to describe the characteristics of data, information and the like for authentication used when a program is transferred between cellular phone 100 and memory card 110 in the communication system of FIG. 1.

A data terminal device (cellular phone) and a memory card are provided with unique public encryption keys KPpy and KPmw, respectively. Public encryption keys KPpy and KPmw are decryptable by a secret decryption key Kpy unique to the data terminal device and a secret decryption key Kmw unique to the memory card, respectively. These public encryption keys and secret decryption keys have a different value for every type of data terminal device and memory card. These public encryption keys and secret decryption keys are generically referred to as “class key”. These public encryption keys are called “class public encryption key”, and these secret decryption keys are called “class secret decryption key”. The unit sharing a class key is called “class”. This class differs depending upon the manufacturer, the type of product, the lot in fabrication, and the like.

Cpy is provided as the class certificate of a data terminal device (cellular phone). Cmw is provided as the class certificate of a memory card. These class certificates include information differing for each class of data terminal devices and memory cards. Any class that has the tamper resistant module broken or the encryption by a class key cracked, i.e. any class having an infringed secret decryption key, will become the subject of license revocation.

The class public encryption key and class certificate of a data terminal device are recorded in a data terminal device in the form of authentication data {KPpy//Cpy} KPa at the time of shipment. The class public encryption key and class certificate of a memory card are recorded at the time of shipment in a memory card in the form of authentication data {KPmw//Cmw} KPa. KPa is a public authentication key common to the entire distribution system, as will be described in detail afterwards.

The key to administer data processing in memory card 110 includes a public encryption key KPmcx set for each memory card medium, and a respectively unique secret decryption key Kmcx that can decrypt data encrypted with public encryption key KPmcx. The public encryption key and secret decryption key unique to each memory card are generically called “unique keys”. Public encryption key KPmcx is called a unique public encryption key, and secret decryption key Kmcx is called a unique secret decryption key.

As an encryption key to maintain secrecy in data transfer between a memory card and a source external to the memory card, common keys Ks1-Ks4 are used. Common keys Ks1-Ks4 are generated at cellular phone 100 and memory card 110 every time content data is to be transferred between a data terminal device (cellular phone) and a memory card.

Here, common keys Ks1-Ks4 are unique common keys generated for every “session” between a data terminal device and a memory card corresponding to a communication or access basis. These common keys Ks1-Ks4 are also called “session keys” hereinafter.

Session keys Ks1-Ks4 are under control of a data terminal device and memory card by having a unique value for every session. Specifically, session key Ks1 is generated by a data terminal device (cellular phone) for every storage (store) of a program into a memory card. Session key Ks2 is generated by a memory card at every storage of a program into the memory card. Session key Ks3 is generated by a memory card at every reproduction of a program, i.e., every storage (restore) of a program to a cellular phone. Session key Ks4 is generated by a cellular phone at every restore of a program to the cellular phone. At each session, these session keys are transmitted/received. Upon receiving a session key generated by the apparatus of the other party, the content data, a license key and the like are transmitted in an encrypted form with the received session key. Thus, the security during a session can be improved.

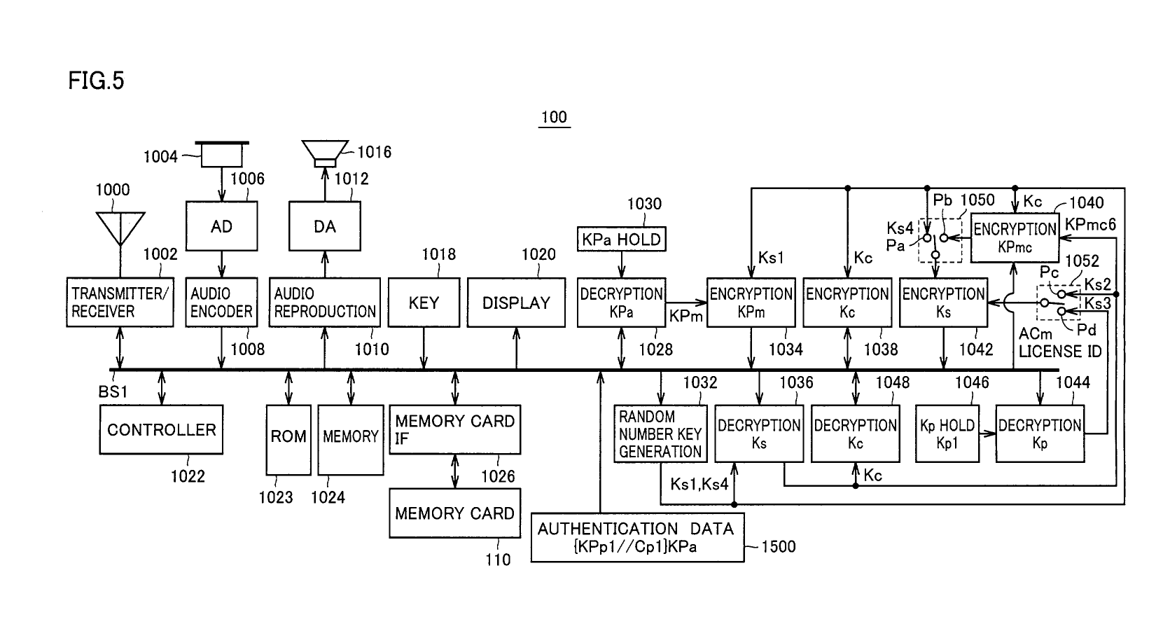

FIG. 5 is a schematic block diagram to describe a structure of cellular phone 100 of FIG. 1.

Cellular phone 100 includes an antenna 1000, a transmitter/receiver unit 1002, a microphone 1004, an AD converter 1006, an audio encoder 1008, an audio reproduction unit 1010, a DA converter 1012, a speaker 1016, a key operation unit 1018, a display 1020, a controller 1022, a ROM 1023, a memory 1024, a memory card interface 1026, decryption processing units 1028, 1036, 1044 and 1048, an authentication key hold unit 1030, a random number key generation unit 1032, encryption processing units 1034, 1038, 1040 and 1042, a Kp hold unit 1046, switches 1050 and 1052, and an authentication data hold unit 1500.

Antenna 1000 receives a signal transmitted through radio by a cellular phone network. Transmitter/receiver unit 1002 receives a signal from antenna 1000 to convert the signal into a baseband signal, or modulates data from cellular phone 100 to provide the modulated data to antenna 1000. Data is transferred among respective components in cellular phone 100 through a bus BS1. Microphone 1004 inputs audio data of the user of cellular phone 100. The audio data is output to AD converter 1006. AD converter 1006 converts the audio data into a digital signal from an analog signal. Audio encoder 1008 encodes the audio signal converted into a digital signal according to a predetermined system. Audio reproduction unit 1010 decodes the audio signal received from another cellular phone. DA converter 1012 converts the audio signal from audio reproduction unit 1010 into an analog signal from a digital signal to output audio data. The audio data is output through speaker 1016.

Key operation unit 1018 provides an external command to cellular phone 100. Display 1020 provides the information output from controller 1022 or the like as visual information. Controller 1022 reads out an operation program stored in ROM 1023 via bus BS1 to carry out various operations that will be described afterwards according to the operation program read out. ROM 1023 stores the operation program executed by controller 1022. Memory 1024 stores a program which is the content data received from distribution server 10, additional information Dc-inf, and list information LST. List information LST includes the stored position, stored date (the date of download to cellular phone) and the like of a content ID, content data Dc and additional information Dc-inf for every program stored in memory 1024 and for every program stored in memory card 110. When stored into memory card 110, the storage position of content data Dc is updated. Also, list information LST is set to indicate the storage. List information LST is generated at cellular phone 100. List information LST for all content data Dc forms one content list CLST. Memory card interface 1026 controls data transfer between memory card 110 and bus BS1.

In a session of storing a program from cellular phone 100 into memory card 110, decryption processing unit 1028 decrypts the authentication data received from memory card 110 using public authentication key KPa from authentication key hold unit 1030. Authentication key hold unit 1030 stores public authentication key KPa. Random number key generation unit 1032 generates session keys Ks1, Ks4 and license key Kc in the session of storing a program into memory card 110 or storing a program from memory card 110 to cellular phone 100.

When a program is to be stored, encryption processing unit 1034 encrypts session key Ks1 generated by random number key generation unit 1032 using a public encryption key KPmw obtained by the decryption at decryption processing unit 1028. The encrypted result is provided onto bus BS1. When a program is to be stored, decryption processing unit 1036 receives via bus BS1 encrypted data encrypted with session key Ks1 from memory card 110, and decrypts the received encrypted data with session key Ks1.

Encryption processing unit 1038 receives a program Dc stored in memory 1024 via bus BS1, and encrypts the received program Dc using license key Kc generated by random number key generation unit 1032. The encrypted program {Dc} Kc is output onto bus BS1. When a program is to be stored, encryption processing unit 1040 encrypts license key Kc generated by random number key generation unit 1032, the license ID that is the administration code to identify a license, and access restrict information ACm using public encryption key KPmcw. The encrypted data {license ID//Kc//ACm} Kmcw is output to a terminal Pb of switch 1050.

When a program is to be stored, encryption processing unit 1042 encrypts encrypted data {license ID//Kc//ACm} Kmcw obtained by sequentially switching terminals Pa and Pb of switch 1050 using session key Ks2. The encrypted data {{license ID//Kc//ACm} Kmcw} Ks2 is output onto bus BS1.

When a program is to be restored, decryption processing unit 1044 receives via bus BS1 encrypted data encrypted with public encryption key KPp from memory card 110, and decrypts the received encrypted data using secret decryption key Kp. Kp hold unit 1046 stores a secret decryption key Kp unique to the class. When a program is to be restored, decryption processing unit 1048 receive encrypted data {Dc} Kc via bus BS1 from memory card 110, and decrypts the received encrypted data {Dc} Kc using license key Kc generated by random number key generation unit 1032. The content data Dc is output onto bus BS1. Authentication data hold unit 1500 stores authentication data {KPp1//Cp1} KPa encrypted in a form that can have its validity confirmed by decrypting class public encryption key KPp1 and class certificate Cp1 using public authentication key KPa. Here, the class y of cellular phone 100 is set as y=1.

The operation of various components of cellular phone 100 in each session will be described in detail with reference to a flow chart.

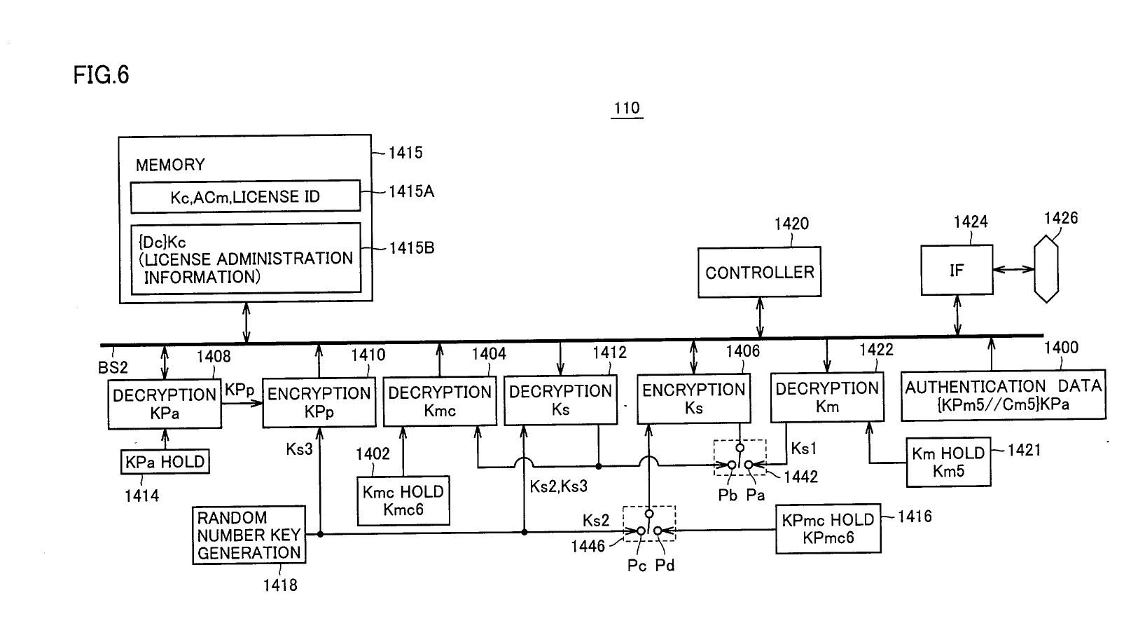

FIG. 6 is a schematic block diagram to describe a structure of memory card 110 of FIG. 1. Referring to FIG. 6, memory card 110 includes an authentication data hold unit 1400, a Kmc hold unit 1402, decryption processing units 1404, 1408, 1412, and 1422, encryption processing units 1406 and 1410, an authentication key hold unit 1414, a memory 1415, a KPmc hold unit 1416, a random number key generation unit 1418, a controller 1420, a Km hold unit 1421, an interface 1424, a terminal 1426, and switches 1442 and 1446.

As mentioned before, KPmw and Kmw are provided as the class public encryption key and class secret decryption key of a memory card, respectively. Also, a class certificate Cmw of a memory card is provided. It is assumed that natural number w is w=5 in memory card 110. Also, it is assumed that the natural number x to identify a memory card is represented as x=6.

Therefore, authentication data hold unit 1400 stores authentication data {KPm5//Cm5}KPa. Data is transferred among respective components of memory card 110 via a bus BS2. Kmc hold unit 1402 stores a unique secret decryption key Kmc6 that is a unique decryption key set for each memory card. Decryption processing unit 1404 decrypts the data on bus BS2 using unique secret decryption key Kmc6 of memory card 110 that is a companion to unique public encryption key KPmc6.

Encryption processing unit 1406 encrypts data selectively applied by switch 1446 using a key selectively applied by switch 1442. The encrypted data is output onto bus BS2. Decryption processing unit 1408 receives public authentication key KPa from authentication key hold unit 1414 to decrypt the data applied from bus BS2 using public authentication key KPa, and provides the decrypted result and obtained class certificate to controller 1420, and the obtained class public key to encryption processing unit 1410. Encryption processing unit 1410 encrypts session key Ks3 output from random number key generation unit 1418 using class public encryption key KPpy obtained by decryption processing unit 1408. The encrypted key is output onto bus BS2.

Decryption processing unit 1412 receives from bus BS2 data encrypted with session key Ks2, and decrypts the received data using session key Ks2 generated by random number key generation unit 1418. Authentication key hold unit 1414 stores public authentication key KPa. KPmc hold unit 1416 stores public encryption key KPmc6 that can be decrypted using unique secret decryption key Kmc6. In the session of program storing or program restoring, random number key generation unit 1418 generates session keys Ks2 and Ks3.

Memory 1415 receives and stores via bus BS2 encrypted content data {Dc}Kc, and a license (Kc, ACm, license ID) required to reproduce encrypted content data {Dc} Kc. Memory 1415 is formed of, for example, a semiconductor memory. Memory 1415 includes a license region 1415A and a data region 1415B. License region 1415A is a region where the license is to be recorded. Data region 1415B is a region to store encrypted content data {Dc}Kc, a license administration file, and a reproduction list file. The license administration file records the license administration information required for license administration for every encrypted content. The reproduction list file stores basic information required to access the encrypted content data and license stored in the memory card. Data region 1415B can be directly accessed from an external source. The details of the license administration file and reproduction list file will be described afterwards.

In license region 1415A are stored licenses in the recording unit exclusive to the license, called entries, to have the license (license key Kc, access restrict information ACm, and license ID) recorded. When access is to be effected with respect to a license, the entry where the license is to be stored or where a license is to be recorded is specified through an entry number.

The entire structure except for data region 1415B is formed of a tamper resistant module region.

Controller 1420 transfers data to/from an external source via bus BS2, and receives various information through bus BS2 to control the operation of memory card 110. Km hold unit 1421 stores a class secret decryption key Km5. Interface 1424 transmits/receives a signal to/from memory card interface 1026 via a terminal 1426. Decryption processing unit 1422 decrypts the data applied onto bus BS2 from interface 1424 using class secret decryption key Km5 from Km hold unit 1421, and provides session key Ks1 generated when cellular phone 100 stores a program to a contact Pa.

By providing an encryption key for a recording apparatus that is a memory card, administration of content data transferred from cellular phone 100 as well as the encrypted license key can be effected on a memory card basis.

The operation of each session in the communication system of FIG. 1 will be described hereinafter.

Program Purchase

The operation of purchasing content data from distribution server 10 by a user of cellular phone 100 in the communication system of FIG. 1 will be describe hereinafter.

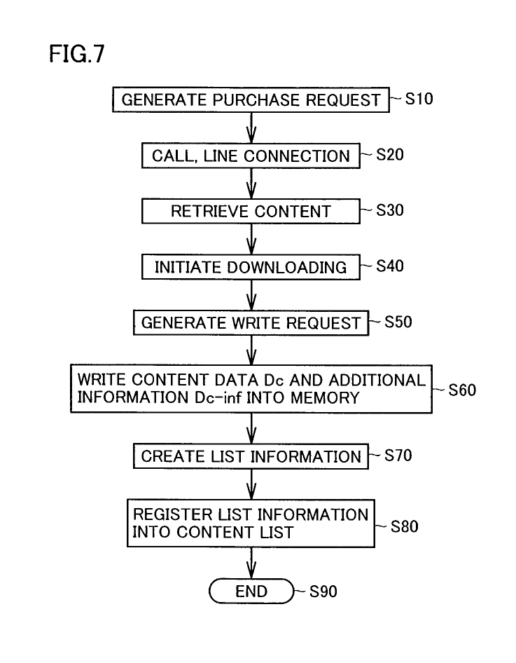

FIG. 7 is a flow chart to describe the operation of transferring content data from distribution server 10 to cellular phone 100.

Upon input of a content data purchase request via key operation unit 1018 of cellular phone 100 (step S10), controller 1022 receives the content data purchase request via bus BS1 to call distribution server 10 via transmitter/receiver unit 1002 and antenna 1000 to connect the line (step S20). Upon receiving a content data purchase request from cellular phone 100, distribution server 10 transmits a list of content data held thereat to cellular phone 100. Controller 1022 of cellular phone 100 receives the content data list via antenna 1000 and transmitter/receiver unit 1002. The received list is displayed on display 1020 via bus BS1. The user of cellular phone 100 views the content data list on the display 1020, and enters a content ID through key operation unit 1018 to identify the content data he/she wishes to purchase. Controller 1022 receives the content ID via bus BS1, and transmits the received content ID to distribution server 10 via transmitter/receiver unit 1002 and antenna 1000.

In response, distribution server 10 searches for the content data based on the received content ID (step S30), and extracts content data Dc specified by the content ID. Then, distribution server 10 transmits the extracted content data Dc to cellular phone 100, whereby downloading of content data Dc is initiated (step S40). In this case, additional information Dc-inf of content data Dc is also distributed to cellular phone 100.

Upon distribution of content data Dc and additional information Dc-inf to cellular phone 100, a write request of content data Dc is generated (step S50). Controller 1022 writes content data Dc received via antenna 1000 and transmitter/receiver unit 1002 into memory 1024 via bus BS1 (step S60). Controller 1022 creates list information LST including the residing position of content data Dc, the received date of content data Dc and the like (step S70). The generated list information LST is registered into content list CLST stored in memory 1024, and written into memory 1024 via bus BS1. Here, the registered position of list information LST on content list CLST may be selected by the user. Controller 1022 writes additional information Dc-inf received together with content data Dc into memory 1024 (step S80). Then, the purchase operation of content data Dc ends (step S90).

Although description has been provided that additional information Dc-inf of content data Dc is distributed together with content data Dc from distribution server 10 to cellular phone 100, additional information Dc-inf may be created at cellular phone 100 receiving content data Dc in the present invention. In this case, controller 1022 of cellular phone 100 generates additional information Dc-inf based on the operation starting from the call to distribution server 10 up to reception of content data Dc. Then, controller 1022 stores the generated additional information Dc-inf into memory 1024.

Program Store

The operation of storing into memory card 110 content data Dc received by cellular phone 100 from distribution server 10 and stored in memory 1024 will be described hereinafter. The operation of recording content data from cellular phone 100 to memory card 110 is called “store”.

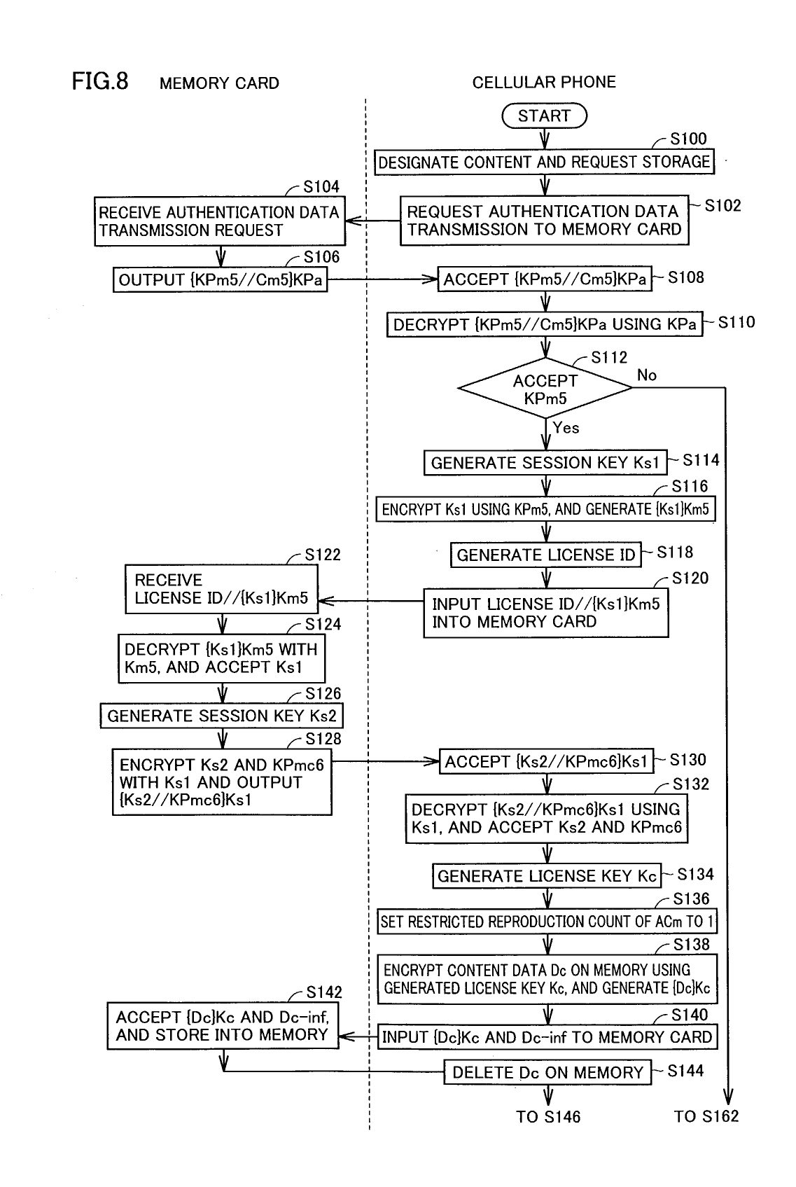

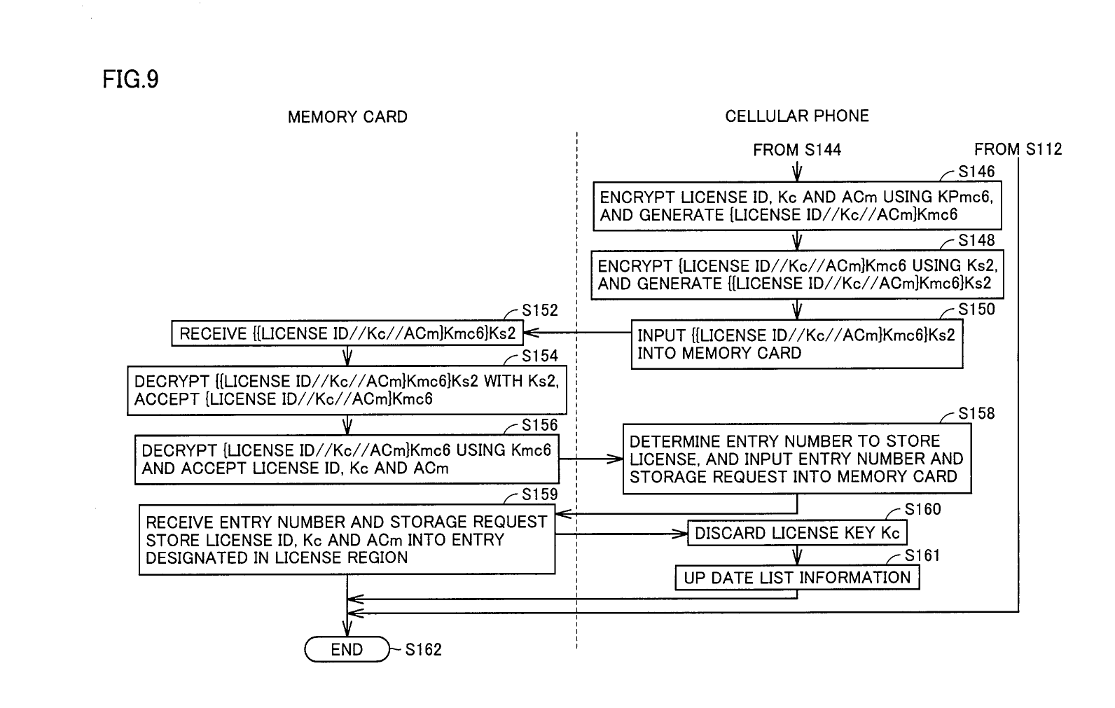

FIGS. 8 and 9 are first and second flow charts, respectively, to describe the operation of storing a program from cellular phone 100 to memory card 110 in the communication system of FIG. 1.

Referring to FIG. 8, the user of cellular phone 100 effects a store request specifying the content data via key operation unit 1018 (step S100).

Upon entry of a content data store request, controller 1022 transmits an authentication data transmission request to memory card 110 via bus BS1 and memory card interface 1026 (step S102). Controller 1420 of memory card 110 receives the authentication data transmission request via terminal 1426, interface 1424 and bus BS2 (step S104). Then, controller 1420 reads out authentication data {KPm5//Cm5) KPa from authentication data hold unit 1400 via bus BS2. The authentication data {KPm5//Cm5} KPa is output via bus BS2, interface 1424 and terminal 1426 (step S106).

Controller 1022 of cellular phone 100 receives authentication data {KPm5//Cm5} KPa from memory card 110 via memory card interface 1026 and bus BS1 (step S108). The received authentication data {KPm5//Cm5} KPa is applied to decryption processing unit 1028. Decryption processing unit 1028 decrypts authentication data {KPm5//Cm5} KPa using public encryption key KPa from authentication key hold unit 1030 (step S110). Controller 1022 carries out an authentication process of determining reception of authentication data subjected to encryption to verify the validity thereof with a proper apparatus from the decrypted processing result of decryption processing unit 1028 (step S112). When determination is made of proper authentication data, controller 1022 authorizes and accepts class public encryption key KPm5 and class certificate Cm5. Then, control proceeds to the next process (step S 114). When the authentication data is not proper, an unauthorized state is identified, and the store operation ends without accepting class public encryption key KPm5 and class certificate Cm5 (step S162).

When authentication is performed and confirmation is made that memory card 110 into which the program is to be stored has the proper authentication data, random number key generation unit 1032 generates a session key Ks1 to store the program (step S114). Encryption processing unit 1034 encrypts session key Ks1 from random number key generation unit 1032 using public encryption key KPm5 from decryption processing unit 1028. Encrypted data {Ks1}Km5 is output onto bus BS1 (step S116). Controller 1022 generates a license ID (step S118), and transmits the generated license ID and encrypted data {Ks1}Km5 from encryption processing unit 1034 as a license ID//{Ks1}Km5 to memory card 110 via bus BS1 and memory card interface 1026 (step S 120).

Controller 1420 of memory card 110 receives license ID//{Ks1}Km5 via terminal 1426, interface 1424 and bus BS2 (step S122). The received encrypted data {Ks1}Km5 is applied to decryption processing unit 1422 via bus BS2. Decryption processing unit 1422 decrypts encrypted data {Ks1}Km5 using secret decryption key Km5 from Km hold unit 1421, and accepts session key Ks1 generated at cellular phone 100 (step S124).

Under control of controller 1420, random number key generation unit 1418 generates a session key Ks2 (step S126). Encryption processing unit 1406 encrypts session key Ks2 and public encryption key KPmc6 received by the sequential switching of contacts Pc and Pd of switch 1446 using session key Ks1 received via contact Pa of switch 1442. Encrypted data {Ks2//KPmc6}Ks1 is output onto bus BS2. Controller 1420 transmits encrypted data {Ks2//KPmc6}Ks1 to cellular phone 100 via bus BS2, interface 1424 and terminal 1426 (step S128).

Controller 1022 of cellular phone 100 receives encrypted data {Ks2//KPmc6}Ks1 via memory card interface 1026 and bus BS1 (step S130). The received encrypted data {Ks2//KPmc6}Ks1 is applied to decryption processing unit 1036 via bus BS1. Decryption processing unit 1036 decrypts encrypted data {Ks2//KPmc6}Ks1 using session key Ks1 generated by random number key generation unit 1032, and accepts session key Ks2 and public encryption key KPmc6 (step S132).

Upon confirming reception of session key Ks2 generated at memory card 110 and public encryption key KPmc6 unique to memory card 110, controller 1022 controls random number key generation unit 1032 so as to generate license key Kc. Random number key generation unit 1032 generates a license key (step S134). Then, controller 1022 sets access restrict information ACm having the number of times of reproduction restricted to 1 (step S136). Controller 1022 reads out content data Dc from memory 1024 via bus BS1. The read out content data Dc is applied to encryption processing unit 1038 via bus BS1. Encryption processing unit 1038 encrypts content data Dc received via bus BS1 using a license key Kc from random number key generation unit 1032. Encrypted content data {Dc}Kc is output onto bus BS1 (step S138). Then, controller 1022 reads out additional information Dc-inf from memory 1024 via BS1 and transmits the read out additional information Dc-inf and encrypted data {Dc}Kc on bus BS1 from encryption processing unit 1038 to memory card 110 via memory card interface 1026 (step S140).

Controller 1420 of memory card 110 receives encrypted content data {Dc}Kc and additional information Dc-inf via terminal 1426, interface 1424 and bus BS2. The received encrypted content data {Dc}Kc and additional information Dc-inf are stored in data region 1415B of memory 1415 via bus BS2 (step S142).

Then, controller 1022 of cellular phone 100 deletes the content data stored in memory 1024 via bus BS1 (step S144).

Referring to the flow chart of FIG. 9, controller 1022 provides a license ID and access restrict information ACm to encryption processing unit 1040 via bus BS1. Encryption processing unit 1040 uses public encryption key KPmc6 from decryption processing unit 1036 to encrypt the license ID and access restrict information ACm received via bus BS1 as well as license key Kc from random number key generation unit 1032. The encrypted data {license ID//Kc//ACm}Kmc6 is output to contact Pb of switch 1050 (step S146). Then, encryption processing unit 1042 encrypts encrypted data {license ID//Kc//ACm}Kmc6} received via contact Pb of switch 1050 using session key Ks2 received via contact Pc of switch 1052. Encrypted data {{license ID//Kc//ACm}Kmc6}Ks2 is provided to bus BS1 (step S148). Then, controller 1022 transmits encrypted data {{license ID//Kc//ACm}Kmc6}Ks2 on bus BS1 to memory card 110 via memory card interface 1026 (step S 150).

Controller 1420 of memory card 110 receives encrypted data {{license ID//Kc//ACm}Kmc6}Ks2 via terminal 1426, interface 1424 and bus BS2 (step S152). Controller 1420 provides encrypted data {{license ID//Kc//ACm}Kmc6}Ks2 to decryption processing unit 1412 via bus BS2. Decryption processing unit 1412 decrypts encrypted data {{license ID//Kc//ACm}Kmc6}Ks2 using session key Ks2, and accepts encrypted data {license ID//Kc//ACm}Kmc6 (step S154). Decryption processing unit 1404 uses secret decryption key Kmc6 from Kmc hold unit 1402 to decrypt encrypted data {license ID//Kc//ACm}Kmc6 decrypted by decryption processing unit 1412, and accepts a license ID, a license key Kc, and access restrict information ACm (step S156).

Then, controller 1022 of cellular phone 100 determines the entry number to store the license. The determined entry number and a license storage request are transmitted to memory card 110 via bus BS1 and memory card interface 1026 (step S158).

Controller 1420 of memory card 110 receives the entry number and storage request via terminal 1426, interface 1424 and bus BS2, and stores the license ID, license key Kc and access restrict information ACm into the designated entry in license region 1415A of memory 1415 (step S 159). Then, controller 1022 of cellular phone 100 discards the generated license key Kc (step S160). The storage is recorded in list information LST stored in memory 1024 to update the list information (step S161). Then, the operation of storing a program into memory card 110 ends (step S162).

Thus, determination is made whether memory card 110 is a proper memory card or not at the time of storing a program corresponding to content data Dc received from distribution server 10 and stored in memory 1024 of cellular phone 100. Content data Dc is transmitted to memory card 110 (refer to step S140 of FIG. 8) only upon confirmation of a proper memory card (refer to step S112 of FIG. 8). Therefore, the program corresponding to content data Dc will not be stored into an improper memory card, and is protected sufficiently.

When the program is to be stored into memory card 110, content data Dc and the license (license key Kc, license ID and access restrict information ACm) are encrypted and transmitted to memory card 110 (refer to step S140 of FIG. 8, and steps S146, S148 and S150 of FIG. 9). The license is transmitted to memory card 110 as encrypted data that can be decrypted using public decryption key Kmc6 possessed by the memory card of the transmission destination. Therefore, the program and license are protected sufficiently since they are transmitted to memory card 110 in an encrypted form. Even if encrypted content data {Dc} Kc and the encrypted license are extracted from the destination memory card 110 by some cause, the encrypted license cannot be decrypted without secret decryption key Kmc6, so that the required license key Kc cannot be obtained. As a result, encrypted content data {Dc} Kc cannot be decrypted to obtain content data Dc.

After encrypted data {Dc} Kc is transmitted to memory card 110, content data Dc is deleted from memory 1024 (refer to step S144 of FIG. 8). Therefore, content data Dc will be stored only in memory card 110. The program cannot be copied for usage. Random number key generation unit 1032, encryption processing unit 1038 and decryption processing unit 1048 of cellular phone 100 are formed of volatile memories. License key Kc required to decrypt encrypted content data {Dc} Kc is stored only in memory card 110.

When encrypted content data {Dc} Kc is transmitted to memory card 110, additional information Dc-inf of content data Dc and list information LST will not be deleted from memory 1024. Therefore, when the user of cellular phone 100 wishes to use a certain program after that certain program is stored into memory card 110, the user can confirm whether that program is stored or not according to the list information LST in memory 1024. When stored, the program can be downloaded from distribution server 10 again based on the URL of distribution server 10 included in additional information Dc-inf stored in memory 1024. Thus, distribution of a program can be facilitated while protecting the copyright.

In other words, cellular phone 100 stores in memory card 110 a program that is content data Dc received from distribution server 10, and delete the program stored in memory 1024. The program stored in memory card 110 can be distributed to a cellular phone differing from the cellular phone that has initially received the distribution by attaching memory card 110 to that another cellular phone. Since the program is deleted from the initially distributed cellular phone, the program will not be copied illegally.

Program Restore

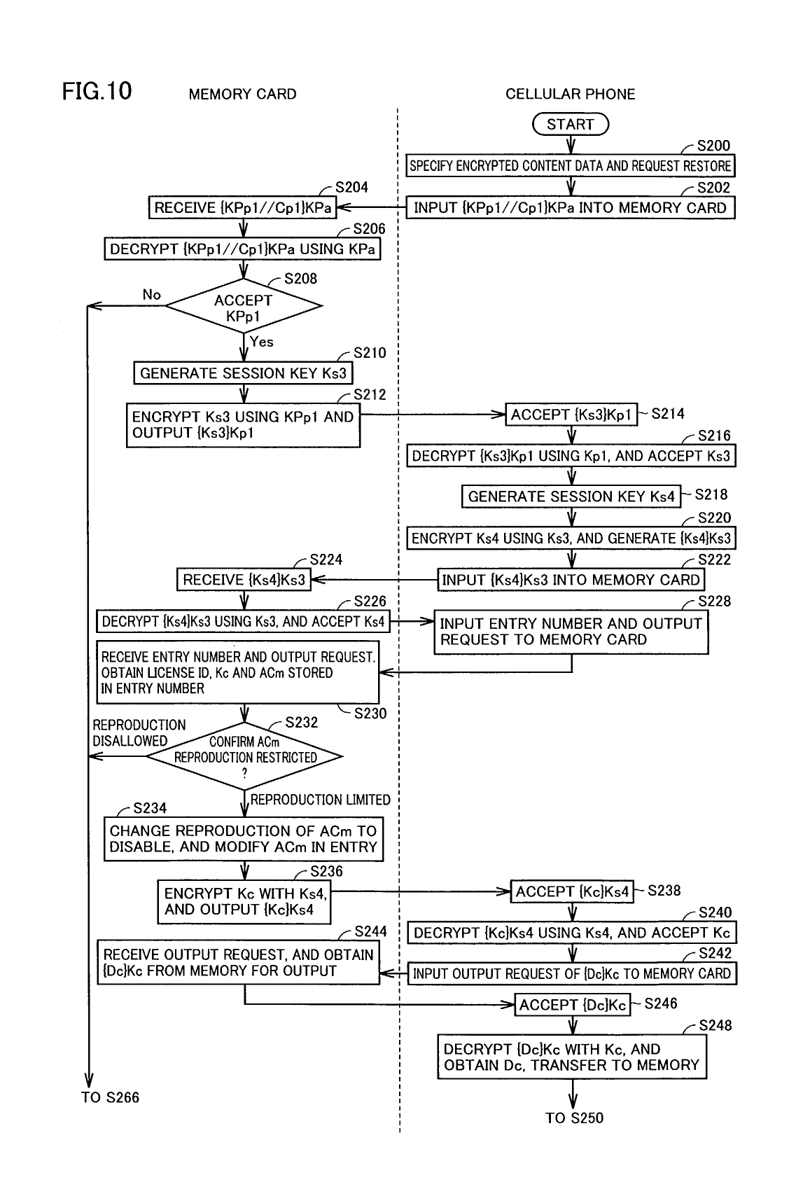

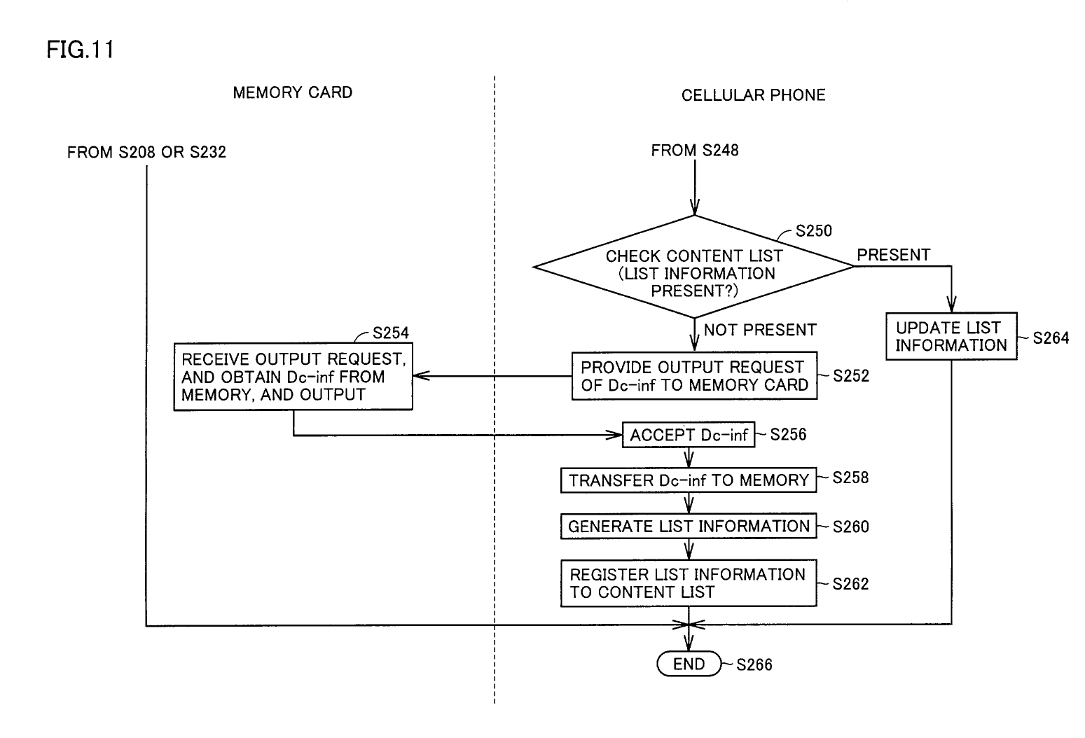

Recording content data Dc stored in memory card 110 into cellular phone 100 will be described with reference to FIGS. 10 and 11. This operation is termed “restore”. The description is based on the postulation that, prior to the process of FIG. 10, the user of cellular phone 100 has determined the content (program) to be obtained from memory card 110, identified the content file, and already obtained the license administration file, according to the reproduction list recorded in data region 1415B of memory card 110.

In response to a restore request specifying the encrypted content data input via key operation unit 1018 by the user into cellular phone 100 (step S200), controller 1022 obtains authentication data {KPp1//Cp1}KPa from authentication data hold unit 1500 via bus BS1. Authentication data {KPp1//Cp1}KPa is transmitted to memory card 110 via memory card interface 1026 (step S202).

Controller 1420 of memory card 110 receives authentication data {KPp1//Cp1}KPa via terminal 1426, interface 1424 and bus BS2 (step S204). The received authentication data {KPp1//Cp1}KPa is applied to decryption processing unit 1408 via bus BS2. Decryption processing unit 1408 decrypts the received authentication data {KPp1//Cp1}KPa using public authentication key KPa from authentication key hold unit 1414 (step S206). Controller 1420 performs an authentication process from the decrypted processing result of decryption processing unit 1408. Specifically, an authentication process of determining whether authentication data {KPp1//Cp1}KPa is proper authentication data or not is conducted (step S208). If decryption is disabled, control proceeds to step S266, and the restore operation ends.

In the case where the authentication data can be decrypted, random number key generation unit 1418 of memory card 110 generates a session key Ks3 for the restore operation (step S210). Encryption processing unit 1410 encrypts session key Ks3 from random number key generation unit 1418 using public encryption key KPp1 decrypted at decryption processing unit 1408. Encrypted data {Ks3}Kp1 is output onto bus BS2. Then, controller 1420 outputs encrypted data{Ks3}Kp1 to memory card interface 1026 via interface 1424 and terminal 1426 (step S212). Controller 1022 of cellular phone 100 accepts encrypted data {Ks3}Kp1 via memory card interface 1026 (step S214). Controller 1022 provides encrypted data {Ks3}Kp1 to decryption processing unit 1044. Decryption processing unit 1044 decrypts encrypted data {Ks3}Kp1 using secret decryption key Kp1 from Kp hold unit 1046, and accepts session key Ks3 (step S216). Decryption processing unit 1044 outputs session key Ks3 to contact Pd of switch 1052.

Then, random number key generation unit 1032 generates a session key Ks4 for a restore operation (step S218). Session key Ks4 is output to contact Pa of switch 1050. Encryption processing unit 1042 uses session key Ks3 received via contact Pd of switch 1052 to encrypt session key Ks4 received via contact Pa of switch 1050. Encrypted data {Ks4}Ks3 is output onto bus BS1 (step S220). Controller 1022 transmits encrypted data {Ks4}Ks3 on bus BS1 to memory card 110 via memory card interface 1026 (step S222).

Controller 1420 of memory card 110 receives encrypted data {Ks4}Ks3 via terminal 1426, interface 1424 and bus BS2 (step S224). The received encrypted data {Ks4}Ks3 is applied to decryption processing unit 1412 via bus BS2. Decryption processing unit 1412 decrypts encrypted data {Ks4}Ks3 using session key Ks3 from random number key generation unit 1418, and accepts session key Ks4 generated at cellular phone 100 (step S226).

In response, controller 1022 of cellular phone 100 transmits the entry number and the output request of encrypted content data {Dc}Kc to memory card 110 via memory card interface 1026 (step S228).

Controller 1420 of memory card 110 receives the entry number and the output request via terminal 1426, interface 1424 and bus BS2. The license ID, license key Kc and access restrict information ACm recorded in the received entry are obtained via bus BS2 (step S230). Controller 1420 refers to the number of times of reproduction in access restrict information ACm. If the number of times of reproduction is set to “0”, determination is made that reproduction is disabled, i.e. license key Kc cannot be output to cellular phone 100. Therefore, the restore operation ends (step S266). Controller 1420 determines that license key Kc can be output to cellular phone 100 if the reproduction count is set to “1”, and proceeds to the next step S234 (step S232). Since the reproduction count is set to “1” (step S136 of FIG. 6) when encrypted content data {Dc}Kc is transmitted to memory card 110, controller 1420 determines that license key Kc can be output to cellular phone 100 at step S232. Then, controller 1420 sets the reproduction count of access restrict information ACm to “0”, i.e., disables reproduction, and modifies access restrict information ACm in the entry (step S234). Accordingly, license key Kc cannot be output from memory card 110 thereafter.

Controller 1420 provides license key Kc to encryption processing unit 1406 via bus BS2. Encryption processing unit 1406 encrypts license key Kc using session key Ks4 received via contact Pb of switch 1442 to output encrypted data {Kc}Ks4 onto bus BS2. Controller 1420 transmits encrypted data {Kc}Ks4 on bus BS2 to cellular phone 100 via interface 1424 and terminal 1426 (step S236).

Controller 1022 of cellular phone 100 receives encrypted data {Kc}Ks4 via memory card interface 1026 and bus BS1 (step S238), and provides the accepted encrypted data {Kc}Ks4 to decryption processing unit 1036 via bus BS1. Decryption processing unit 1036 decrypts encrypted data {Kc}Ks4 using session key Ks4 from random number key generation unit 1032 to accept license key Kc (step S240). In response, controller 1022 transmits the output request of encrypted content data {Dc}Kc to memory card 110 via memory card interface 1026 (step S242).

Controller 1420 of memory card 110 receives the output request of encrypted content data {Dc}Kc via terminal 1426, interface 1424 and bus BS2 to obtain encrypted content data {Dc}Kc from data region 1415B in memory 1415 via bus BS2, and transmits encrypted content data {Dc}Kc to memory card 110 via interface 1424 and terminal 1426 (step S244).

Controller 1022 of cellular phone 100 receives encrypted content data {Dc}Kc via memory card interface 1026 (step S246), and provides the received encrypted content data {Dc}Kc to decryption processing unit 1048 via bus BS1. Decryption processing unit 1048 decrypts encrypted content data {Dc}Kc using license key Kc from decryption processing unit 1036 to obtain content data Dc. Controller 1022 transfers content data Dc to memory 1024 via bus BS1 (step S248).

Referring to FIG. 11, controller 1022 of cellular phone 100 confirms, succeeding step S248, whether list information LST corresponding to content data Dc is present in content list CLST stored in memory 1024 (step S250). When list information LST is present in content list CLST, controller 1022 registers the content data Dc transferred to memory 1024 into list information LST and updates list information LST (step S264). Thus, the series of operation ends (step S266).

In the case where list information LST is not present in content list CLST, controller 1022 transmits the output request of additional information Dc-inf to memory card 110 via bus BS1 and memory card interface 1026 (step S252). Controller 1420 of memory card 110 receives the output request via terminal 1426, interface 1424 and bus BS2. Additional information Dc-inf is obtained from data region 1415B in memory 1415 via bus BS2. Controller 1420 transmits additional information Dc-inf to cellular phone 100 via interface 1424 and terminal 1426 (step S254).

Controller 1022 of cellular phone 100 accepts additional information Dc-inf via memory card interface 1026 and bus BS1 (step S256). The accepted additional information Dc-inf is transferred to memory 1024 via bus BS1 (step S258). Controller 1022 generates list information LST corresponding to content data Dc (step S260). The created list information LST is registered in content list CLST (S262). Thus, the restore process ends (step S266).

The determination at step S250 corresponds to a process of checking whether content data Dc is newly read into cellular phone 100. If not new, reading in additional information Dc-inf is not required. If new, reading in additional information Dc-inf together with content data Dc is required as in a newly purchase operation through downloading.

When the program i.e., content data stored already in memory card 110 from cellular phone 100 is output from memory card 110 and stored again into cellular phone 100, the reproduction count of content data Dc is set to “0” and output when stored into cellular phone 100 (refer to step S234 of FIG. 10). Accordingly, license key Kc cannot be output from memory card 110 thereafter. This means that license key Kc stored in memory card 110 is substantially deleted. Therefore, by storing content data Dc into memory card 110 with the reproduction count set to “1”, and setting the reproduction count to “0” to disable reproduction when content data Dc is output from memory card 110, encrypted content data {Dc} Kc stored in memory card 110 can no longer be used. As a result, the available content data Dc is only that stored in cellular phone 100 in the restore operation of content data. Even if encrypted content data {Dc} Kc left in memory card 110 is copied, that copied encrypted content data {Dc} Kc cannot be decrypted for usage unless license key Kc required to decrypt encrypted content data {Dc} Kc is generated. Therefore, encrypted content data {Dc} Kc can be deleted immediately after the restore operation, although not indicated in the flow chart of FIGS. 10 and 11.

The present invention is characterized in that, when an apparatus (for example, memory card) storing content data Dc transmitted from another apparatus (for example, cellular phone) outputs the content data, content data Dc stored in its own region is deleted or inhibited of usage thereafter. As a method of disabling usage of content data Dc by memory card 110, the number of times of reproduction of content data Dc is set to “0”, whereby license key Kc required to use content data Dc is substantially deleted. This deletion method takes advantage of the fact that a memory card is used in an attached manner to an apparatus such as a cellular phone, and content data Dc stored in the memory card must be output from the memory card for usage.

When content data Dc is output from the memory card, the manner of deleting content data Dc from the memory card, or the manner of being restricted equivalent to deletion is arbitrary in the present invention.

Since a program can be stored from cellular phone into memory card, the program received at a certain cellular phone can be executed at another cellular phone, when changed. The user does not have to receive the same program again from the distribution server even if his/her cellular phone is changed.

Furthermore, the storage of a program from a cellular phone to a memory card facilitates distribution of a program while inhibiting copy thereof.

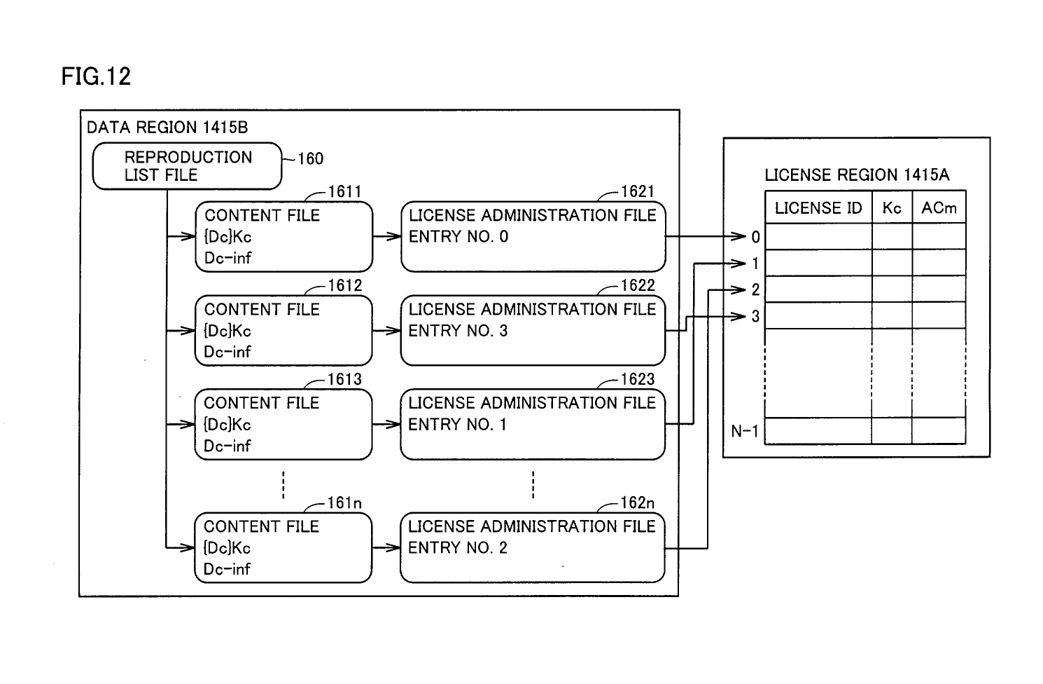

FIG. 12 shows a license region 1415A and a data region 1415B in memory 1415 of memory card 110. In data region 1415B are stored a reproduction list file 160, content files 1611-16 in, and license administration files 1621-162n. Content files 1611-161n record the received encrypted content data {Dc}Kc and additional information Dc-inf as one file. License administration files 1621-162n are recorded corresponding to content files 1611-161n, respectively.

Upon receiving encrypted content data and a license from cellular phone 100, memory card 110 records the encrypted content data and the license in memory 1415.

The license of the encrypted content data transmitted to memory card 110 is recorded in a region specified by the entry number in license region 1415A of memory 1415. The entry number can be obtained by reading out the license administration file of reproduction list file 160 recorded in data region 1415B in memory 1415. The corresponding license can be read out from license region 1415A according to the obtained entry number.

For example, entry number “0” can be obtained by reading out license administration file 1621 corresponding to content file 1611. The license of encrypted content data {Dc}Kc stored in content file 1611 can be obtained from the region specified by entry number “0” in license region 1415A. The same applies for a license recorded in a region specified by other entry numbers.

The above description is based on the case where a program is stored from a cellular phone to a memory card, and then restored. The present invention includes the case where a program is transmitted from a cellular phone to another cellular phone. In this case, the program stored in the built-in memory is to be deleted after transmission of the program to another cellular phone, similar to the above-described cellular phone 100.

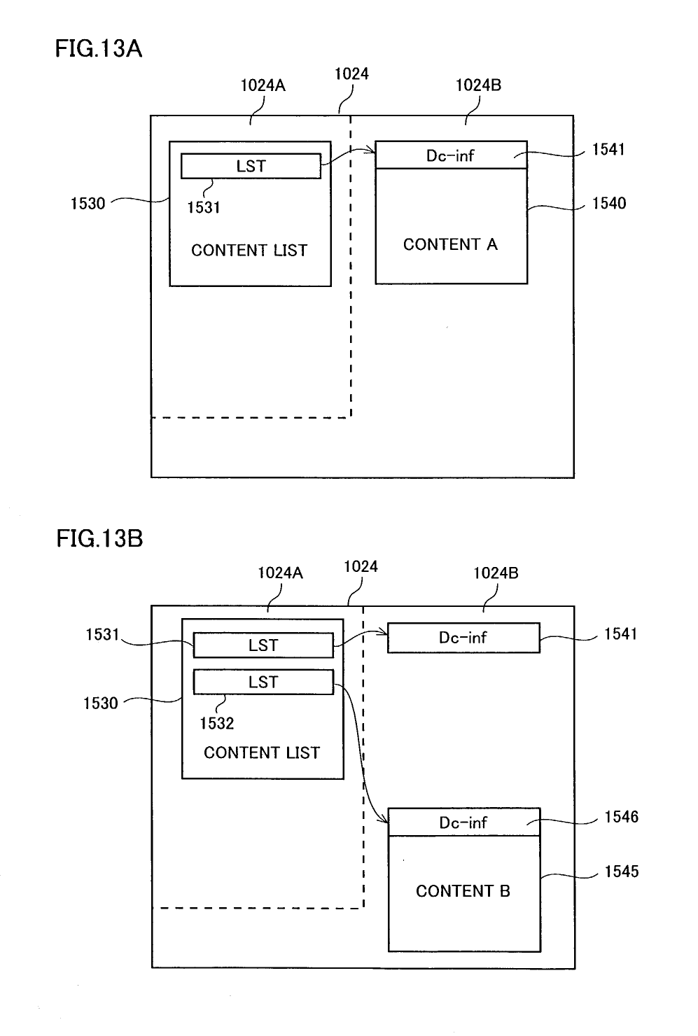

Referring to FIGS. 13A and 13B, memory 1024 of cellular phone 100 includes a list region 1024A and a data region 1024B. This region 1024A stores content list CLST1530. Data region 1024B stores content data Dc1540 and additional information Dc-inf1541. Content list CLST1530 has list information LST1531 of content A registered (refer to FIG. 13A). Therefore, when cellular phone 100 receives content data Dc and additional information Dc-inf from distribution server 10, content data Dc and additional information Dc-inf are stored in data region 1024B (refer to step S60 of FIG. 7). The created list information LST is stored in list region 1024A (refer to step S80 of FIG. 7).

Here, description is provided with two content data Dc by way of example. To discriminate the two content data, one is called content A and the other is called content B.

The state shown in FIG. 13A corresponds to the case where content A is stored in memory 1024 in a usable state. FIG. 13B corresponds to the state where content A in the state of FIG. 13A is stored from cellular phone 100 into memory card 110 according to the flow charts of FIGS. 8 and 9, and content B is newly received at cellular phone 100 from distribution server 10 according to the flow chart of FIG. 7. In FIG. 13B, content data Dc1540 of content A is deleted, and content data Dc1545 and additional information Dc-inf1546 of content B are newly recorded. Also, list information LST1532 of content B is added into content list CLST1530. It is to be noted that, although additional information Dc-inf1541 of content A remains unchanged, list information LST1531 is updated (refer to step S161 of FIG. 9). Specifically, the stored position of content data Dc in list information LST for content A is updated from a position on memory 1024 of cellular phone 100 to memory card 110.

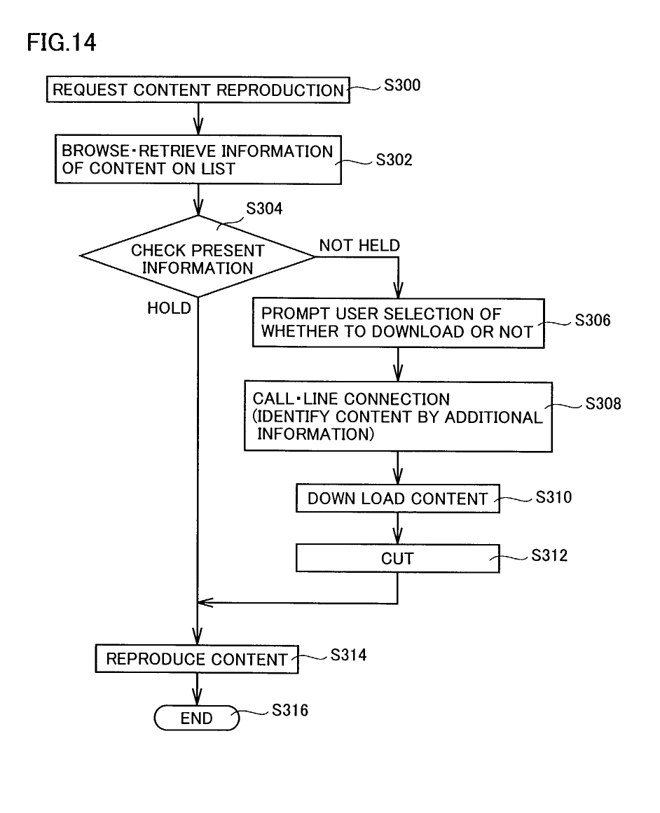

The operation of reproducing content data Dc at cellular phone 100 will be described with reference to FIG. 14. Upon input of a reproduction request via key operation unit 1018 of cellular phone 100 (step S300), controller 1022 receives the reproduction request via bus BS1. List information LST stored in list region 1024A of memory 1024 is read out via bus BS1, and the content corresponding to the reproduction request is searched for (step S302).

Controller 1022 checks where content data Dc corresponding to the reproduction request is present based on list information LST read out (step S304). When determination is made that content data Dc resides in memory 1024, control proceeds to step S314. When determination is made that content data Dc is not present, control proceeds to step S306.

When determination is made that content data Dc is not present in memory 1024 at step S304, i.e., when determination is made of a reproduction request of content A, a message of whether to download or not taking into consideration the status of the storage in the memory card owned by the user is provided on display 1020. Waiting is conducted for selection by the user (step S306). Upon input of a request indicating that download is not to be carried out by the user through key operation unit 1018, the reproduction process ends. If a download request is input by the user through key operation unit 1018, controller 1022 reads out additional information Dc-inf of content data Dc corresponding to the reproduction request from data region 1024B of memory 1024. Based on the telephone number and URL of the download destination of content data Dc included in additional information Dc-inf read out, a call is made to distribution server 10 to connect the line. Then, controller 1022 identifies content data Dc according to the content ID included in additional information Dc-inf (step S308). Content data Dc is received again from distribution server 10 (step S310). Upon the end of download of content data Dc, the line is cut (step S312).

When determination is made that content data Dc is present in memory 1024, i.e. when determination is made of a reproduction request of content B at step S304, or after step S312, controller 1022 reads out content data Dc from memory 1024, and executes the program which is the read out content data Dc. Controller 1022 provides various visual information on display 1020 according to the executed program. Accordingly, content data Dc is reproduced (step S314). The entire operation ends (step S316).

The above-described content list is capable of a representation that allows discrimination between the contents present in the memory and contents not present in the memory. In the case where the user is aware of the presence of the content at the time a reproduction request is generated, step S306 of prompting the user for selection of download is not necessarily required. Therefore, when determination is made at step S304 that content data is not to be retained, control may proceed to step S308 skipping step S306.

The above description is based on an operation of a cellular phone that, when content data Dc is to be stored into memory card 110, automatically deletes content data Dc stored in memory 1024, updates the contents of list information LST, and leaves additional information Dc-inf in memory 1024, and when the stored content data Dc is to be used again, refers to additional information Dc-inf restored from memory card 110 or stored in memory 1024 to obtain content data from distribution server 10 again to use the content data.

One reason why the user stores content data into memory card 110 is due to the limited size of data that can be stored in memory 1024. In order to obtain and store new content data, content data that is currently not used must be saved into memory card 110 to ensure the space to store new content data. For a similar aim, the user may delete content data Dc stored in memory 1024. The present invention is characterized in that, when the user operates to delete content data Dc stored in memory 1024, the specified content Dc is deleted and the list information is updated to indicate that content data Dc has been deleted. Additional information Dc-inf is left in memory 1024. When the user looks into the content list and finds content data Dc that has been deleted but is to be used again, the user can refer to additional information Dc-inf stored in memory 1024 to obtain again content data Dc from distribution server 10 to use content data Dc.

Although deletion of list information LST, has not been described above, it is to be noted that list information LST, when exceeding the permissible amount, must also be deleted since the recording area of memory 1024 in cellular phone 100 is limited. One such method is to set the number of list information LST that can be registered in content list CLST to n (n is a natural number) in advance, and have list information LST corresponding to a designation by the user or of the oldest content data among the stored or deleted content data automatically deleted when the number of list information exceeds the preset “n”. When list information LST is deleted, additional information Dc-inf identified by the relevant list information LST is deleted together. In the case where list information LST corresponding to the oldest content data among the stored or deleted content data is to be deleted automatically, the date when content data Dc is stored or deleted is written into the relevant list information LST at the update of list information LST.

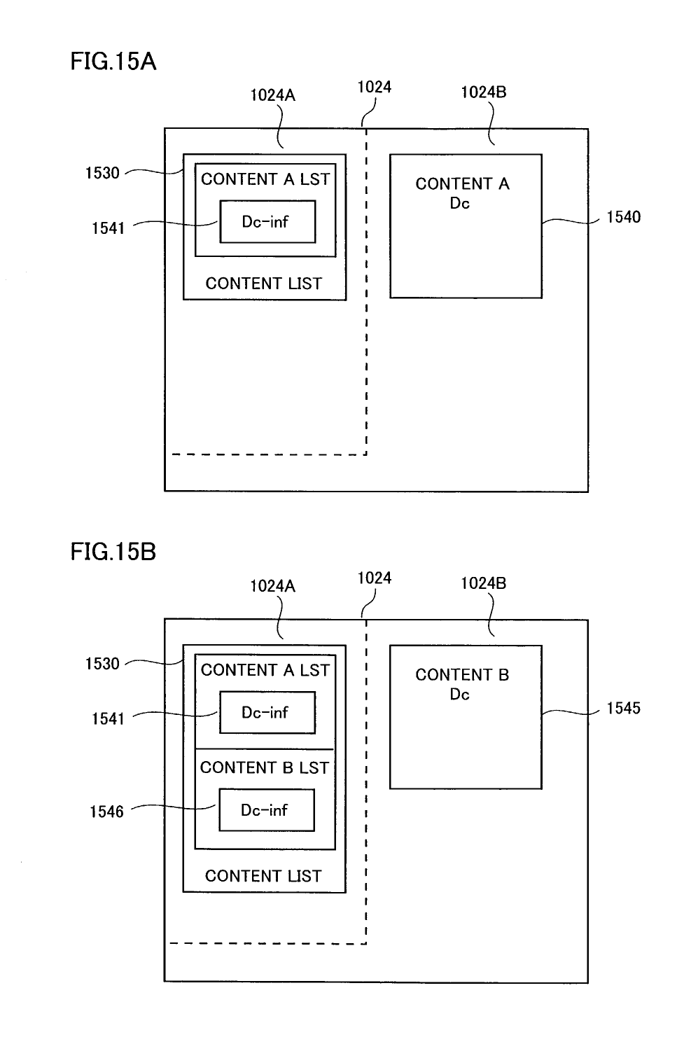

Although the above description is based on a structure in which content data Dc and additional information Dc-inf are simply stored in memory 1024, a structure in which additional information Dc-inf is stored so as to be included in list information LST as shown in FIGS. 15A and 15B can be employed. In this case, additional information Dc-inf is output from the corresponding list information LST to be stored in memory card 110 together with content data Dc when content data Dc is stored into memory card 110 or deleted.

Furthermore, a structure may be employed in which all or part (at least the information required to obtain content again is included) of the additional information is transcribed into list information LST. In this case, content data Dc and additional information Dc-inf are simply stored in memory 1024 as shown in FIGS. 13A and 13B. All or some of additional information Dc-inf is included in list information LST as shown in FIGS. 15A and 15B. When content data Dc is stored into memory card 110 or deleted, the information required to obtain the content data included in additional information Dc-inf is stored in list information LST, additional information Dc-inf is deleted together with deletion of content data Dc. In a restore operation, additional information Dc-inf is obtained together with content data Dc from memory card 110 to be stored in memory 1024.

The above description is based on the case where one content data is distributed to cellular phone 100. In general, a plurality of content data are distributed from distribution server 10 to cellular phone 100 to be stored in memory 1024 of cellular phone 100. At cellular phone 100, the distributed content data is stored in memory 1024 together with the additional information and list information in the manner shown in FIGS. 13A and 13B or FIGS. 15A and 15B.

When content data distributed to cellular phone 100 is stored into memory card 110, additional information of the stored content data remains in memory 1024 of cellular phone 100. Therefore, when the user of cellular phone 100 wants to use the program stored into memory card 110 again, the program can be re-obtained based on URL and the like of distribution server 10 included in additional information. Thus, a program received from distribution server 10 can be stored into memory card 110 to be distributed to another cellular phone while protecting the copyright thereof.

ROM 1023 of cellular phone 100 stores a program to execute the content data purchase operation shown in FIG. 7, the program to execute the content data store operation shown in FIGS. 8 and 9, the program to execute the content data restoring operation shown in FIGS. 10 and 11, and the program to execute the content data reproduction operation shown in FIG. 14. When the above operation is executed, controller 1022 reads out the relevant program stored in ROM 1023 to execute an appropriate operation according to the program read out. Cellular phone 100 includes a terminal (not shown) to be connected to a CD-ROM drive through a cable. Controller 1022 obtains each of these programs from a CD-ROM through cable for storage into ROM 1023. Therefore, the program to effect each operation executed at cellular phone 100 is provided in the manner stored in a recording medium in the present invention.

Cellular phone 100 can receive the program to execute each of above-described operations via the Internet for storage into memory 1024.

According to an embodiment of the present invention, the cellular phone receiving a program (content data) from a distribution server stores the received program and additional information of that program in its own memory. When the received program is to be stored into a memory card, the cellular phone deletes only the program held therein. The cellular phone obtains again the program stored in a memory card based on the additional information held therein. It is therefore possible to distribute a program to another apparatus while inhibiting copying of the program.

The content data of interest in the present invention includes, but not limited to, a program. All copyrighted works that can be reproduced through a data terminal device are of interest. Although the above description is based on a communication system with a communication protocol between a cellular phone and a memory card, the communication capability between a cellular phone and a distribution server is not always necessary. Content data can be obtained from a distribution server through wire. Furthermore, the reproduction capability of content data is not always necessary.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data terminal device obtaining content data and acquirement information required to obtain again said content data from an external source, and storing said content data and said acquirement information for usage of said content data, comprising:
an operation unit to input a designation,
a storage unit storing said content data and said acquirement information, and
a control unit,
wherein said control unit
when content data stored in said storage unit is to be deleted according to a designation from said operation unit, controls said storage unit so as to retain acquirement information corresponding to said content data to be deleted,
when a designation from said operation unit to use deleted content data, obtains said deleted content data again from an external source for storage in said storage unit based on said acquirement information stored in said storage unit.

2. The data terminal device according to claim 1, wherein said storage unit further stores a list information including a storage status and identification code of a plurality of content data currently stored or previously stored,
wherein said control unit,
when content data and acquirement information are newly obtained according to a designation from said operation unit, stores said newly obtained content data and acquirement information in said storage unit, and adds the storage status and identification code corresponding to said newly obtained content data to said list information,
when content data stored in said storage unit is to be deleted according to a designation from said operation unit, modifying the storage status corresponding to said content data to be deleted so as to confirm that said deleted content data is not stored in said storage unit,
when said deleted content data is obtained again from an external source, modifies the storage status corresponding to said content data obtained again so as to confirm that said content data obtained again is stored in said storage unit, and
when usage of content data is designated from said operation unit, confirms whether said designated content data is stored in said storage unit based on said list information.

3. The data terminal device according to claim 2, wherein said list information further includes said acquirement information,
wherein said control unit, when content data is newly obtained from an external source, also obtains acquirement information corresponding to said obtained content data, and stores said obtained acquirement information in said list information.

4. The data terminal device according to claim 1, further comprising an interface to transfer data with respect to a data recording apparatus,
wherein said control unit deletes said content data when said content data is transmitted to said data recording apparatus via said interface.

5. The data terminal device according to claim 2, further comprising an interface to transfer data with a data recording apparatus,
wherein said control unit updates said list information when said content data is transmitted to said data recording apparatus via said interface, and deletes said content data.

6. The data terminal device according to claim 5, further comprising an encrypted content generation unit generating a license key required to decrypt encrypted content data that is an encrypted version of said content data, and encrypting said content data using said generated license key to generate said encrypted content data,
wherein, when said content data is transmitted to said data recording apparatus,
said encrypted content generation unit generates said license key and encrypts said content data using said generated license key, and
said control unit transmits encrypted content data generated by said encrypted content generation unit to said data recording apparatus via said interface.

7. The data terminal device according to claim 6, further comprising a license generation unit generating a license including said license key, and required to substantially delete from said data recording apparatus said license key recorded in said data recording apparatus when said license key is output from said data recording apparatus.

8. The data terminal device according to claim 7, wherein said license generation unit generates said license from a usage rule having the number of times of decrypting and reproducing said encrypted content data set to once and said license key.

9. The data terminal device according to claim 8, wherein said encrypted content generation unit comprises
a key generation unit generating said license key, and
an encryption processing unit encrypting said content data using said license key.

10. The data terminal device according to claim 1, wherein, when said content data is to be obtained, said control unit obtains only said content data, not said acquirement information, when acquirement information corresponding to said content data is present in said storage unit.

11. The data terminal device according to claim 1, wherein said content data is data or program that can be executed in plain text.

12. The data terminal device according to claim 1, wherein said control unit stores obtained acquirement information into said storage unit when said acquirement information corresponding to said content data is obtained together with said content data.

13. The data terminal device according to claim 1, wherein said control unit, when said content data is obtained from an external source, generates acquirement information corresponding to said obtained content data, and stores said generated acquirement information into said storage unit.

14. A program to cause a computer to execute:
a first step of obtaining content data in plain text,
a second step of storing in a storage unit additional information including at least access information required to access a source where said content data is obtained and said obtained content data,
a third step of generating a license key required to decrypt encrypted content data that is an encrypted version of said content data, and encrypting said content data using said generated license key to generate encrypted content data,
a fourth step of generating a license including said license key, and required to substantially delete said license key recorded in a data recording apparatus from said data recording apparatus when said license key is output from said data recording apparatus,
a fifth step of generating an encrypted license which is an encrypted version of said license,
a sixth step of transmitting said encrypted content data, said encrypted license, and said additional information to said data recording apparatus, and
a seventh step of deleting said content data stored in said storage unit.

15. The program according to claim 14, wherein said additional information is generated when said content data is obtained at said first step.

16. The program according to claim 14, wherein said additional information is obtained together with said content data in said first step.

17. A computer-readable recording medium recorded with the program defined in claim 14.
